(19) United States
(12) Patent Application Publication
(10) Pub. No.: US 2012/0048124 A1
(43) Pub. Date: Mar. 1, 2012

(54) VACUUM INFUSION PRODUCTION PLANT

(75) Inventors: Vygantas Kirejevas, Tallinn (EE); Aram Kazarjan, Tallinn (EE)

(73) Assignee: BACTERFIELD OU, Tallinn (EE)

(21) Appl. No.: 13/265,424

(22) PCT Filed: Apr. 23, 2010
(86) PCT No.: PCT/EP10/55461

§ 371 Date: Nov. 14, 2011

(30) Foreign Application Priority Data
Apr. 23, 2009 (EP) 09158595.0

(51) Int. Cl. A23L 1/29

(52) U.S. Cl. 99/472

(57) ABSTRACT

The invention relates to a production plant for vacuum infusing a food product comprising at least a first storage tank for storing a probiotic suspension, said first storage tank being connected to a first dosage tank for dosing a probiotic suspension, a second storage tank for storing a second solution, said second storage tank being connected to a second dosage tank for dosing the second solution, and wherein the first dosage tank and the second dosage tank are connected to a vacuum infusion tank by one or more spraying nozzles leading into the vacuum infusion tank, and wherein at least the first dosage tank is individually connected to the vacuum infusion tank by one or more first spraying nozzles leading into the vacuum infusion tank.

### TECHNICAL FIELD OF THE INVENTION

The present invention relates to a vacuum infusion production plant. In particular the present invention relates to a vacuum infusion production plant for infusing probiotic micro-organisms into extruded food products.

### BACKGROUND OF THE INVENTION

Various commercial attempts have been made to achieve food compositions containing probiotic micro-organisms with prolonged viability for long term storage, many of these do not provide sufficient efficacious levels of viable probiotic micro-organism due to issues associated with susceptibility of the micro-organism to standard commercial pet food manufacturing procedures such as extrusion. For example, efforts of coating or filling standard pet food kibbles with probiotic micro-organisms have been suggested but, in practice, often prove impractical.

WO 01/95745 provides a method of producing a food product (kibbles) characterised by a porous structure, comprising an instable substrate such as a probiotic micro-organism in an oil solution, which are included in a flowable form into the product by means of a step of “partial vacuum” followed by normalizing the pressure by releasing an inert gas into the vessel.

WO 05/070232 provides a method of producing a food product similar to WO 01/95745, further characterized in that the oil should have a solid fat index of at least 20. WO 05/070232 discloses the essential use of fat with the solid fat index of the vehicle is at least 20 at 20° C. and the preferred vehicle are coconut oil and even more preferred palm oil.

WO 03/009710 discloses system and method for on-line mixing and application of surface coating compositions for food products; an apparatus is also disclosed. The apparatus comprises a dry matter-liquid mixing module (wherein the dry matter may be probiotics) connected inline to a liquid-liquid mixing module, wherein one or more liquid can be mixed into the first liquid (potentially comprising the probiotics)

Hence, an improved production plant for incorporating probiotics into food products would be advantageous, and in particular a more efficient and/or reliable production plant for incorporating probiotics into food products prolonging the viability of the probiotics would be advantageous.

### SUMMARY OF THE INVENTION

A first aspect the invention relates to a production plant for vacuum infusing a food product comprising
a first storage tank for storing a probiotic suspension, connected to a first dosage tank for dosing a probiotic suspension,
   wherein the first dosage tank is connected to a vacuum infusion tank by one or more spraying nozzles leading into the vacuum infusion tank.

A second aspect relates to a production plant for vacuum infusing a food product comprising at least
a first storage tank for storing a probiotic suspension, said first storage tank being connected to a first dosage tank for dosing a probiotic suspension,
a second storage tank for storing a second solution, said second storage tank being connected to a second dosage tank for dosing the second solution,
   wherein the first dosage tank and the second dosage tank are connected to a vacuum infusion tank by one or more spraying nozzles leading into the vacuum infusion tank, and wherein at least the first dosage tank is individually connected to the vacuum infusion tank by one or more first spraying nozzles leading into the vacuum infusion tank.

It may be advantageously to be able to vacuum infuse more than two suspension/solution without having to change the content of the storage tank and the dosage tank. Thus, in a third aspect the invention relates to a production plant for vacuum infusing a food product comprising at least
a first storage tank for storing a probiotic suspension, said first storage tank being connected to a first dosage tank (6) for dosing a probiotic suspension,
a second storage tank for storing a fat solution, said second storage tank being connected to a second dosage tank for dosing a fat solution,
a third storage tank for storing a digest solution, said third storage tank being connected to a third dosage tank for dosing a digest solution, and
   wherein the first dosage tank, the second dosage tank and the third dosage tank are connected to a vacuum infusion tank by one or more spraying nozzles leading into the vacuum infusion tank, and wherein at least the first dosage tank is individually connected to the vacuum infusion tank by one or more first spraying nozzles leading into the vacuum infusion tank.

In the production plant of the disclosed invention the probiotic suspension is kept separate from the other components which are going to be vacuum infused into the product. This is done having the first dosage tank individually connected to the vacuum infusion tank. An advantage is that optimal viability of the probiotics is maintained when the probiotic oil/fat suspension is applied without getting in contact with the other ingredients before it reach the vacuum tank.

The solutions in the second dosage tank and the third dosage tanks may be connected to the vacuum infusion tank through a joined connection, which may make the plant simpler to construct.

### BRIEF DESCRIPTION OF THE FIGURES

FIG. 1 shows one embodiment of the invention illustrating tanks, vessels connections and the like which may form part of the production plant according to the invention.

FIG. 2 shows another embodiment of the invention illustrating tanks, vessels connections and the like which may form part of the production plant according to the invention.

### DETAILED DESCRIPTION OF THE INVENTION

### Definitions

Prior to discussing the present invention in further details, the following terms and conventions will first be defined:

### Extrusion

The terms “extrusion” or “extruded” refers in the present context to “cooking extrusion” which is a combination of heating of food products with the act of extrusion to create a cooked and shaped food product and is a process in which moistened, starchy, proteinaceous foods are cooked and worked into a viscous, plastic-like dough. The results of cooking the food ingredients during extrusion may be: 1) gelatinization of starch, 2) denaturation of protein, 3) inactivation of raw food enzymes, 4) destruction of naturally occurring toxic substances, and 5) diminishing of microbial counts originating from the pre-extruded product. Upon discharge through the die, the hot, plastic extrudate expands rapidly with loss of moisture and heat because of sudden decrease in pressure. After expansion cooling, and drying, the extruded product develops a rigid structure and maintains a porous texture.

### Probiotic

The term “probiotic” as used herein is defined as a live microbial feed supplement which beneficially affects the host animal (such as a human being or a pet animal) by improving its intestinal microbial balance.

Examples of suitable probiotic micro-organisms include yeasts such as Saccharomyces, Debaromyces, Candidaw Pichia and Torulopsis, moulds such as Aspergillus, Rhizopus, Mucor, and Penicillium and Torulopsis and bacteria such as the genera Bifidobacterium, Bacteroides, Clostridium, Fusobacterium, Melissococcus, Propionibacterium, Streptococcus, Enterococcus, Lactococcus, Kocuriaw, Staphylococcus, Peptostrepococcus, Bacillus, Pediococcus, Micrococcus, Leuconostoc, Weissella, Aerococcus, Oenococcus and Lactobacillus. Specific examples of suitable probiotic micro-organisms are: Aspergillus niger, A. oryzae, Bacillus coagulans, B. lentus, B. licheniformis, B. mesentericus, B. pumilus, B. subtilis, B. natto, Bacteroides amylophilus, Bac. capillosus, Bac. ruminocola, Bac. suis, Bifidobacterium adolescentis, B. animalis, B. breve, B. bifidum, B. infantis, B. lactis, B. longum, B. pseudolongum, B. thermophilum, Candida pintolepesii, Clostridium butyricum, Enterococcus cremoris, E. diacetylactis, E. faecium, E. intermedius, E. lactis, E. muntdi, E. thermophilus, Escherichic coli, Kluyveromyces fragilis, Lactobacillus acidophilus, L. alimentarius, L. amylovorus, L. crispatus, L. brevis, L. Casei, L. curvatus, L. cellobiosus, L. delbrueckii ss. bulgaricus, L farciminis, L. fermenturn, L. gasseri, L. helveticus, L. lactis, L. plantarum, L. johnsonii, L. reuteri, L. rhamnosus, L. sakei, L. salivarius, Leuconostoc mesenteroides, P. cereviseae (damnosus), Pediococcus acidilactici, P. pentosaceus, Propionibacterium freuclenreichii, Prop. shertnanii, Saccharontyces cereviseae, Staphylococcus carnosus, Staph. xylosus, Streptococcus infantarius, Strep. Salivarius ss. thermophilus, Strep. thermophilus, Strep. lactis.

### Viscosity

The term “viscosity” refers a measure of the resistance of a fluid which is being deformed by either shear stress or extensional stress. In everyday terms (and for fluids only), viscosity is “thickness”. The coefficient of viscosity is most often used as a value for viscosity. The shear viscosity and dynamic viscosity are most frequently used. “Dynamic viscosity” (or absolute viscosity) is a unit of measuring viscosity. The SI physical unit of dynamic viscosity is the pascal-second (Pa·s), which is identical to kg·m⁻¹·s⁻¹. If a fluid with a viscosity of one Pa·s is placed between two plates, and one plate is pushed sideways with a shear stress of one pascal, it moves a distance equal to the thickness of the layer between the plates in one second. The cgs physical unit for dynamic viscosity is the poise. It is more commonly expressed, particularly in ASTM standards, as centipoise (cP). The relation between poise and pascal-seconds is: 1 cP=0.001 Pa·s=1 mPa·s. Water at 20° C. has a viscosity of 1.0020 cP. Dynamic viscosity is measured with various types of rheometer, for example Physica MCR 301 as used in Example 1. The temperature dependence of the viscosity of the fluid is the phenomenon by which fluid viscosity generally decrease (or, alternatively, its fluidity generally increases) as its temperature increases. Thus, close temperature control of the fluid is essential to accurate measurements, particularly in materials like lubricants, whose viscosity can double with a change of only 5° C. The dynamic viscosity referred to in the context of the present invention is the dynamic viscosity at 20° C. if noting else is stated. In the context of the present invention the change in dynamic viscosity of an oil is expressed as Δ Pa·s/° C.

The term “viscosity” as used herein also refers to the resistance of a fluid which is being deformed by either shear stress or extensional stress. In everyday terms (and for fluids only), viscosity is “thickness”. The SI physical unit of dynamic viscosity is the pascal-second (Pa·s), which is identical to kg·m⁻¹·s−1.

### Colony-Forming Unit

The term “colony-forming unit (CFU)” is a measure of viable bacterial or fungal numbers. Unlike in direct microscopic counts where all cells, dead and living, are counted, CFU measures viable cells.

### Food Product

The term “food product” as used herein refers to any food product to which the beneficial function of probiotics is wished to be added. For example, it may be a breakfast cereals, pet food, animal feed, treats. However, it may be any food, intended for any humans and/or animals. For example, the food product may be a particulate food or food ingredient, such as extruded snack products, tortilla chips, breakfast cereal, cookies, crisp bread, food foams, Rice brokens, blend of peanut, soybean and corn, puffed wheat, low density foamed corn and rice breakfast, Co-extruded products, muesli bars and any other extruded products that are formed by extrusion process.

### Suspension

The term “suspension” refers to a fluid (such as an oil) containing particles that will not dissolve in the fluid and are sufficiently large for sedimentation such as freeze dried micro-organisms. A homogenous suspension refers to a suspension, wherein the particles are dispersed throughout the external phase (the fluid) through mechanical agitation (such as mixing). The suspended particles (e.g. micro-organisms) are visible under a microscope and will settle over time if left undisturbed. It is to be understood that an oil vehicle is also a suspension comprising probiotics.

### Antioxidant

The term “antioxidant” refers to a substance capable of slowing or preventing the oxidation of other substances. Antioxidants are frequently used as food additives to reduce food deterioration. Both synthetic and natural antioxidants are used. Natural antioxidants have been identified among a wide range of classes of compounds such as flavanoids, cartonoids, tocotrienol, tocopherol and terpenes (such as astaxanthin).

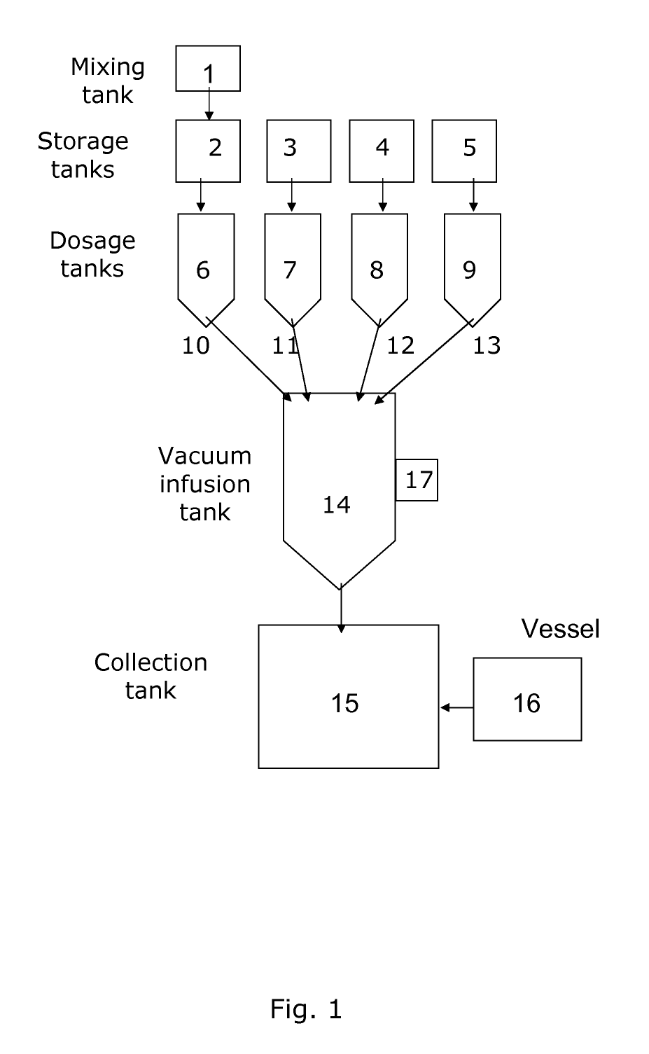

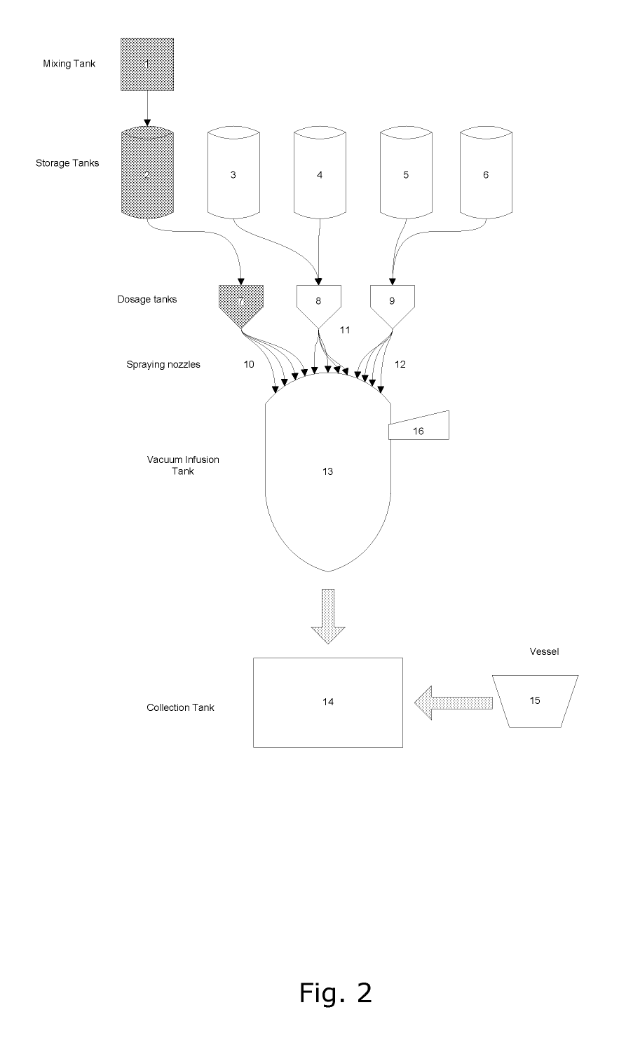

The numbering refers to FIG. 1, but the preson skilled in the art would easily be able to convert this numbering to the numbering indicated in FIG. 2 where appropriate.

The plant may comprise one or more storage tanks 2-5 which can be used to store individual solutions, such as a probiotic suspension, a solution of fat, and a solution of digest. The storage tank 2 may be further connected to a mixing tank 1. The reason is that mixing of an oil/fat suspension with a freeze dried probiotic powder, may result in precipitation of the probiotics if the powder is not mixed slowly into to oil/fat suspension. This mixing may be performed manually. The mixing tank 1 may be physically positioned above the storage tank 2. In this way the suspension in the mixing tank 1 may be transferred to the storage tank 2 through an outlet positioned at the bottom of mixing tank 1. Furthermore, this setup means that the transfer can be performed only by the force of gravity, which may be beneficial for the viability of the probiotics in the suspension.

The storage tank 2 and the dosage unit tank 6 for storing and dosing a probiotic suspension may comprise means for mixing the suspension such as an impeller or a rotational tank or a combination of both. The other storage and dosage tanks may comprise similar means for mixing. Each of the storage tanks 2-5 may then be further connected to individual dosage tanks 6-9. Each of the dosage tanks 6-9 may then be further connected to a single vacuum infusion tank 14. These connections are in one embodiment spraying nozzles 10-13 connection each dosage tank individually to the vacuum infusion tank 14, allowing for spraying the content of each of the dosage unit tanks individually on the food products present in the vacuum infusion tank 14. This is important to avoid mixing of the oil/fat suspension comprising probiotics with one or more of the other solutions, since intermixing may lower the viability of the probiotics. Thus, at least the spraying nozzles leading from the probiotic-oil/fat suspension to the vacuum infusion tank should not be connected to any of the other dosage tanks. This is in contrast to WO 03/009710, which teaches away from keeping the suspension comprising the probiotics separate from all other liquids until the reach the solid food product.

The precise shape of the spraying nozzles may vary, since the form and shape of the nozzles have to be optimized to the solution/suspension which is going to be sprayed through the nozzles.

The vacuum infusion tank may furthermore comprise one or more openings 17 for receiving a food product. When the food product is in place in the tank the following steps may take place:
a) reduction of the pressure in the vacuum infusion tank to 0.2-0.95 bar,
b) vaporization of one of the solutions from one of the dosage unit tanks 6-9 through the corresponding one or more spraying nozzles 10-13 at e.g. a temperature below 29° C.,
c) restore pressure to 1 bar,

Steps a)-c) may then be repeated with other solutions (or the same solution) to further vacuum infusions into the food product. This is important for getting the subsequent solutions infused into the product. The release of the vacuum may be performed slowly to avoid abrupt changes in pressure which may be harmful to the product and/or the probiotics.

The reduction in the pressure in the vacuum infusion tank (step a) may also be in the range 0.2-8 bar.

Similar the temperature range in step B may be 15-30° C., such as 15-29° C. or such as 20-29° C.

Some vacuum tanks are designed to release the pressure in the vacuum tank using an inert gas, which may actually be harmful for the viability of the probiotics. Thus, in an embodiment the pressure release is not performed with an inert gas such as nitrogen and carbondioxide. It is to be understood that release of the pressure using atmospheric air is part of the invention though atmospheric air comprises nitrogen and carbondioxide.

To get the sprayed solutions evenly distributed in the infusion tank some kind of mixing may be required. Thus, the mixing tank (vacuum infusion tank 14) may be able to rotate or comprise an impeller or the like. Therefore it may be advantageously if the mixing is performed during the spraying steps or after each of the spraying steps.

Thus, in an embodiment the vacuum infusion tank comprises at least one of the following means for mixing: a rotating impeller, a rotating mixing tank.

The vacuum infusion tank may also comprise an outlet leading to a collection vessel 15. The collection tank 15 may be particular useful, when a coating is also required on the food product (which is not going to be vacuum infused). Such a coating may be stored in a vessel 16 connected to the collection tank 15. Examples of coatings could be suspensions comprising honey, natural sweeteners, artificial sweeteners, vitamins, tartar or other additives or the like.

In the following sections the inventions will be discussed in further detail.

To be able to produce a food product comprising probiotics a production plant is necessary. Thus in a first aspect the invention relates to a production plant for vacuum infusing a food product comprising
a first storage tank for storing a probiotic suspension, connected to a first dosage tank for dosing a probiotic suspension,
   wherein the first dosage tank is connected to a vacuum infusion tank by one or more spraying nozzles leading into the vacuum infusion tank.

In this way the probiotic suspension may be sprayed onto the food product positioned in the vacuum infusion tank.

### Plant

It may be advantageously to be able to vacuum infuse two suspensions/solutions without having to change the content of the storage tank and the dosage tank.

Thus, in an embodiment the production plant further comprises a second storage tank for storing a second solution, connected to a second dosage tank for dosing the second solution, wherein the second dosage tank is connected to a vacuum infusion tank by one or more spraying nozzles leading into the vacuum infusion tank, and wherein the first dosage tank is individually connected to a vacuum infusion tank by one or more spraying nozzles leading into the vacuum infusion tank.

A second aspect relates to a production plant for vacuum infusing a food product comprising at least
a first storage tank for storing a probiotic suspension, said first storage tank being connected to a first dosage tank for dosing a probiotic suspension,
a second storage tank for storing a second solution, said second storage tank being connected to a second dosage tank for dosing the second solution,
   wherein the first dosage tank and the second dosage tank are connected to a vacuum infusion tank by one or more spraying nozzles leading into the vacuum infusion tank, and wherein at least the first dosage tank is individually connected to the vacuum infusion tank by one or more first spraying nozzles leading into the vacuum infusion tank.

In the production plant of the disclosed invention the probiotic suspension is kept separate from the other solution which may be vacuum infused into the product. This is done having the first dosage tank individually connected to the vacuum infusion tank. An advantage is that optimal viability of the probiotics is maintained when the probiotic oil/fat suspension is kept distinct from the other solution. It is to be understood that the oil/fat suspension may comprise antioxidants and or other preservatives. The aspect and embodiments relating to at least two storage and dosage tanks may be especially suited for certain human product where two vacuum coating steps may be optimal. Example 2 discloses a method of coating a human food product, wherein the coating process comprises two independent vacuum coating steps (suspension and syrup).

Thus, in an embodiment the second storage tank and second tank are intended for a solution selected from the group consisting of: a syrup, a digest, a fat solution and a flavour. In a further embodiment the second storage tank and second tank are intended for a flavour component such as a syrup.

It should be noted that embodiments and features described in the context of one of the aspects of the present invention also apply to the other aspects of the invention. Thus, embodiments and features relating to the production plant in the following aspects of the invention also apply to other aspects disclosing a production plant.

### Plant Variations

It may be advantageously to be able to vacuum infuse more than two suspension/solution without having to change the content of the first or second storage tank and the first and second dosage tank.

Thus, in an embodiment the invention relates to a production plant further comprising at least a third storage tank (4) for storing a solution, said third storage tank (4) being connected to a third dosage tank (8) for dosing the third solution through one or more spraying nozzles.

Thus, in a third aspect the invention relates to a production plant for vacuum infusing a food product comprising at least
a first storage tank for storing a probiotic suspension, said first storage tank being connected to a first dosage tank (6) for dosing a probiotic suspension,
a second storage tank for storing a fat solution, said second storage tank being connected to a second dosage tank for dosing a fat solution,
a third storage tank for storing a digest solution, said third storage tank being connected to a third dosage tank for dosing a digest solution, and
   wherein the first dosage tank, the second dosage tank and the third dosage tank are connected to a vacuum infusion tank by one or more spraying nozzles leading into the vacuum infusion tank, and wherein at least the first dosage tank is individually connected to the vacuum infusion tank by one or more first spraying nozzles leading into the vacuum infusion tank.

In the production plant of the disclosed invention the probiotic suspension is kept separate from the other components which are going to be vacuum infused into the product. This is done having the first dosage tank individually connected to the vacuum infusion tank. An advantage is that optimal viability of the probiotics is maintained when the probiotic oil/fat suspension is kept distinct from the other solutions. This aspect of the invention may be especially suited for certain pet food production lines where three vacuum coating steps may be an advantage. Example 1 shows an example of a three step coating of a pet food kibble.

It is to be understood that though the above aspect specifically relates to a production plant for coating a suspension, a fat mixture and a digest mixture, the plant may also be used for coating other substances onto a food product. Thus in an alternative aspect the invention relates to a production plant for vacuum infusing a food product comprising at least
a first storage tank for storing a first solution, said first storage tank being connected to a first dosage tank (6) for dosing the first solution,
a second storage tank for storing a second solution, said second storage tank being connected to a second dosage tank for dosing the second solution,
a third storage tank for storing a third solution, said third storage tank being connected to a third dosage tank for dosing the third solution, and
   wherein the first dosage tank, the second dosage tank and the third dosage tank are connected to a vacuum infusion tank by one or more spraying nozzles leading into the vacuum infusion tank, and wherein at least the first dosage tank is individually connected to the vacuum infusion tank by one or more first spraying nozzles leading into the vacuum infusion tank.

In a preferred embodiment the first solution is a probiotic suspension.

Non-limiting examples of alternative solutions to be vacuum infused are flavour solutions, syrups and vitamin solutions. This is of course in addition to to the previously mentioned solutions such as probiotic suspension, fat, digest and syrups.

The solutions in the second dosage tank and the third dosage tanks may be connected to the vacuum infusion tank through a joined connection, which may make the plant simpler to construct.

Other solutions may be vacuum infused into the product of the invention. Thus, in another embodiment the production plant further comprises at least a fourth storage tank for storing a solution, said fourth storage tank being connected to a fourth dosage tank for dosing a solution through one or more spraying nozzles.

The fourth storage tank and the fourth dosage tank may be optimized for storing additional solutions. The solutions in the second dosage tank, the third dosage tank and the fourth dosage tank may be connected to the vacuum infusion tank through a joined connection, which may make the plant simpler to construct.

It may also be advantageously to avoid intermixing of some of the solutions present in the dosage tanks. Thus, in another embodiment the invention relates to a production plant, wherein at least one of the following dosage tanks also is individually connected to the vacuum infusion tank by one or more spraying nozzles: the second dosage tank, the third dosage tank and the fourth dosage tank.

This may be advantageously, since intermixing of two or more of the different solutions may result in precipitation and clotting of the spraying nozzles.

### Intermixed Dosage Tanks

In some cases none of the solutions in the dosage tanks should be intermixed before they enter the vacuum infusion tank. Therefore, in yet another embodiment the invention relates to a production plant, wherein each of the following dosage tanks also is individually connected to the vacuum infusion tank by one or more spraying nozzles: the second dosage tank, the third dosage tank and the fourth dosage tank. This may be advantageously, since intermixing of two or more of the different solutions may result in precipitation and clotting of the spraying nozzles. Another advantage may be that e.g. the fourth storage tank and the fourth dosage tank can be saved as an extra infusion line in the case that e.g. the nozzles in one of the dosage tanks clots. In this way a fast switch can be made to the fourth infusion line and thus save expensive “down-time” where the plant may be out of order. It is to be understood that “infusion line” refers to the combination of vessels leading to the vacuum tank, e.g. the fourth storage tank leading to the fourth dosage tank leading to the vacuum infusion tank through one or more spraying nozzles.

### Spraying Nozzles Orifice

Since different solutions are being sprayed onto the food products optimal spraying is required. Thus, in a further embodiment the invention relates to a production plant according to any of claims 1-4, wherein the orifice of each of the spraying nozzles has a cross-sectional area of 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm². The importance of having optimal nozzles for each type of solution is that the efficiency of the spraying is depending on the orifice of each of the spraying nozzles and the viscosity of the solution passing through the nozzle. Furthermore, spraying also depend on the speed the solution is passed through the nozzle. Thus, it is to be understood that each infusion line do not necessary have the same type of spraying nozzles.

### Cross-Sectional Area

Therefore, in an additional embodiment the orifice of each of the spraying nozzles connected to the first dosage tank has a cross-sectional area of 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm², and the orifice of each of the spraying nozzles connected to the second dosage tank has a cross-sectional area of 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm², and the orifice of each of the spraying nozzles connected to the third dosage tank has a cross-sectional area of 1-250 mm², possibly 1-200 mm², such as 1-150 mm², or 1-100 mm², or 1-50 mm², or 1-25 mm², or 1-15 mm2 or 1-10 mm2 or 1-5 mm2 or 1-3 mm2, and the orifice of each of the spraying nozzles connected to the fourth dosage tank has a cross-sectional area of 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm².

Optimal spraying through the nozzles also depend on the viscosity of the fluids. The spraying nozzles for spraying the suspension is preferably designed for a suspension having a dynamic viscosity of less than 0.08 pascal-second (Pa·s) at 20° C., such as less than 0.075 pascal-second (Pa·s) at 20° C., for example less than 0.070 pascal-second (Pa·s) at 20° C., such as less than 0.065 pascal-second (Pa·s) at 20° C., for example less than 0.060 pascal-second (Pa·s) at 20° C., such as less than 0.055 pascal-second (Pa·s) at 20° C., for example less than 0.050 pascal-second (Pa·s) at 20° C., such as less than 0.045 pascal-second (Pa·s) at 20° C., for example less than 0.040 pascal-second (Pa·s) at 20° C. In one embodiment, the dynamic viscosity of the vehicle oil is less than 0.060 pascal-second (Pa·s) at 20° C. In a further, embodiment, the dynamic viscosity of the vehicle oil within the range of 0.050 to 0.07 pascal-second (Pa·s) at 20° C., such as the range of 0.053 to 0.066 pascal-second (Pa·s) at 20° C.

Another parameter which may influence the efficiency of the nozzles is the change in viscosity in the range between 20° C. and 25° C., since vacuum infusion in this temperature range is optimal for maintaining a high viability of the probiotics.

### Bottom Outlet

To be able to maintain a high viability of the probiotics during the whole process of vacuum infusion, correct handling of the solution is required. Thus, in yet a further embodiment the invention relates to a production plant, wherein a first mixing tank is connected to the first storage tank through a bottom outlet in the first mixing tank, and where the probiotic suspension is intended for being passed from the first mixing tank to the first storage tank at least by means of gravity, possibly by means of gravity only. An advantage of having an additional mixing tank is that mixing dried probiotics into the oil/fat suspension may result in flakes/precipitates of microorganisms if the microorganisms are added too fast to the suspension. Furthermore, manually mixing may be advantageously. An example of a mixing tank is an IBC tank. When the suspension is transferred to the first storage tank it is also important not to supply too much force to the suspension since it may result in loss of viability of the probiotics. By having an outlet positioned at the bottom of the mixing tank and the first storage tank positioned below the mixing tank, the suspension can be transferred to the storage tank only by the force of gravity.

### Vacuum Suction Unit Proviso

Thus, in an embodiment the connection between the first mixing tank and the first storage tank does not comprise a vacuum suction unit. In another embodiment the connection between the first mixing tank and the first storage tank does not comprise a positive displacement unit. Both a vacuum suction unit and a positive displacement unit may be harmful to the viability of the probiotics. Furthermore by minimizing the surfaces the probiotics come in contact with, loss of probiotics due to sticking to the surfaces of e.g. long tubes, loss of viability may also be avoided.

### Mixing Means

It is important that the probiotics stay/become evenly distributed in the suspension when the suspension is maintained in the first storage tank. Thus, in a further embodiment the first storage tank comprises at least one of the following means for mixing: a rotating impeller, a rotating mixing tank, or a combination of an impeller and a rotating tank. By having the first storage tank comprising means for mixing, such as an impeller, a rotating tank or a combination of both, sedimentation of the probiotics may be avoided. The person skilled in the art would know of other means for mixing which may be suitable for the described purpose. When an impeller is used for mixing the speed of the mixing may be controlled to optimize mixing, to minimize lose of viability but at the same time keep a homogenous suspension. Thus, the speed of the impeller in storage tank 2 may be 50-1000 rpm when the impeller has a radius of approximately 5-150 cm, such as 5-50 cm, such as 50-150 cm, such as 50-100 cm or such as 100-150 cm. The person skilled in the art would now how to convert rcf (relative centrifugation force=“g”) to rpm (revolutions per minute) or vice versa. E.g. by applying the formula:

rcf=11.18*r*(rpm/1000)̂2.

Thus, by knowing the radius (r) the skilled person would be able to calculate the relative centrifugation force.

Thus, in a embodiment speed of the impeller in storage 2 is 50-1000 rpm, such as 50-500 rpm, such as 50-300 rpm, such as 50-300 rpm, or such as 100-200 rpm.

### Opening for Applying Uncoated Food

The vacuum infusion tank also has to be able to receive the food product (not yet infused) before the vacuum infusion begins. Thus, in yet an embodiment the vacuum infusion tank comprises at least one opening for applying the uncoated food product to said vacuum infusion tank. The food product (before infusion) may be transferred to the vacuum infusion tank directly from a drying device, which means that the un-infused food product may have a temperature above ambient temperature when it enters the vacuum infusion tank. Thus, in an embodiment the vacuum infusion tank is connected to a drying device. A higher amount of solutions/suspensions are being infused into the product when the product has a temperature of 20-50° C., such as 20-45° C., 25-50° C., 30-45° C. without resulting in significant loss of viability of the probiotics. Such temperature ranges are conductive to coating process, because the kibble pores in this way are maximally opened and it creates a “sponge” effect which promotes the overall coating process.

### Pressure

The vacuum infusion tank may be constructed to decrease the pressure inside the tank to a vacuum. Thus, in an embodiment the pressure inside vacuum infusion tank can be adjusted to pressures in the range of 0.01 bar-1.5 bar, such as 0.01 bar-1.5 bar, such as 0.05 bar-1.5 bar, such as 0.05 bar-1 bar, such as 0.1 bar-1 bar, such as 0.05 bar-0.1 bar, such as 0.1 bar-0.3 bar, such as 0.3 bar-0.5 bar, such as 0.5 bar-0.7 bar, or such as 0.7 bar-0.9 bar. By having the possibility also to increase the pressure above 1 bar a larger pressure difference may be achieved following pressure release, which may result in a better vacuum infusion.

### Collection Tank

Following vacuum infusion the food product (now comprising probiotics) may require additional coatings, which is not vacuum-infused. Thus, in a further embodiment the vacuum infusion tank is further connected to a collection tank for passing the coated food product from the infusion tank to the collection tank, and wherein the collection tank is further connected to at least one vessel containing one or more substances to be applied to the collection vessel. Since not all solutions are suitable for being applied to a product through spraying, e.g. due to a high viscosity or because the solution comprises components which due to the size may clot the spraying nozzles other means for applying such solutions may be required. Furthermore, applying additional means for adding a solution to the vacuum infusion tank, may be inappropriate since high viscosity solutions may still result in damage to the spraying nozzles already positioned inside the vacuum infusion tank. The collection tank may receive a solution from one or more vessels by e.g. a standard tube, pibe or hose.

### Collection Tank Mixing Means

It may become difficult to get the one or more solutions evenly distributed on the vacuum infused food products. Thus, in yet a further embodiment the collection tank comprises at least one of the following means for mixing: a rotating impeller, a rotating mixing tank. The person skilled in the art would know of other means for mixing.

### Temperature Control

It is important to provide environmental conditions during the whole production, which are advantageously for the viability of the probiotics. Thus, in an embodiment at least the first storage tank and the first dosage tank comprise means for maintaining the temperature of the probiotic suspension in the range of 15°-29° C. (not exceeding 30° C.). Alternatively the temperature is in the range 15-40° C., such as 20-40° C., 25-40° C. or such as 20-30° C. Probiotics are in general sensitive towards temperature variations therefore control of temperature is advantageously. Furthermore, to provide products which have a constant viability count between different productions sessions, temperature control of at least some of the tanks which comprises probiotics may be an advantage. Since both the temperature of digest and animal fat can be higher than for the suspension, dependingly on the consistency and quality of the animal fat and digest, without influencencing the quality of the end product, the temperature control interval may go up to 60° C.

Thus, in an embodiment the temperature of the animal fat is kept at an temperature range of 15-60°, such as 15-50° C., such as 15-40° C., within the animal fat storage tank.

In another embodiment the temperature of the digest is kept at an temperature range of 15-60° C., such as 15-50° C., such as 15-40° C., within the digest storage tank.

It may be difficult to control the production plant manually, since it comprises many individual components. Thus, in a further embodiment the plant further comprises a control unit for controlling at least one of the activities selected from the group consisting of: controlling the temperature in at least one of the storage tanks, controlling the temperature in at least one of the dosage tanks, controlling opening and closing of inlets and outlets between two or more of the tanks, controlling the amount of liquid sprayed through the nozzles from the individual dosage tanks, controlling the pressure in the vacuum tank and controlling the mixing speed and time.

### EXAMPLES

### Example 1

### Probiotic Dog Food Production

The numbering refers to FIG. 1, but the person skilled in the art would easily be able to convert this numbering to the numbering indicated in FIG. 2 where appropriate.

### Set Up Parameters—INPUT

All ingredients used in the dry meal were grinded with a sieve of 1 mm and the average particle size not exceeded 1.5 mm. Moisture level was at 10.48% in the meal.

The extrusion speed was set up to 3800 kg/h to receive kibbles with a density from 360-380 g/l. Dryer temperature was set up to 120° C. and the moisture of kibbles after sieving stage was 6.20%.

The ratio of probiotic bacteria in the end product was set at 1.2 kg per ton of product. Freeze-dried Enterococcus faecium NCIMB 10415 EC No. 13 (E1707 (new classification)) probiotic bacteria powder with 1×10¹³ CFU/kg (from suppliers certificate of analysis) was pre order for the production (Probiotics International Ltd UK). Laboratory analysis of freeze-dried E. faecium probiotic bacteria powder gave an average concentration of 1.4×10¹³ CFU/kg in the raw probiotic powder used in the particular production.

The preparation of the suspension (oil and bacteria mixture) was done at the earliest one hour before the first vacuum infusion procedure to minimize the risk of oxidation. The storage tank (2) comprising an impeller was completely empty before filling it with the suspension. All residue of a production were eliminated and were not used anymore.

Before the production the animal fat and digest were placed into separate storage tanks (storage tank (3) and storage tank (4) correspondingly).

For each batch of 500 kg of salmon oil, 18 kg of bacteria powder was added and suspension was mixed for not less than 1 hour in a separate, specialized storage tank (2) comprising an impeller in it to form a ready suspension. Mixing speed was set to 180 rpm. At the stage of bacteria powder addition into the salmon oil the temperature of oil was 26° C. and during mixing in storage tank (2), suspension temperature was not less than 22° C. The oil used in this particular production batch was a salmon oil (International Quality Ingredients BV (Netherlands)).

Pressure parameters for the vacuum infusion tank (14) were set up to 650 mbar for chicken fat and digest; and 850 mbar for the suspension. The spraying of the added liquids and suspension was done in 3 stages:

Stage 1—animal fat comprising chondroition & glucoseamine,
Stage 2—salmon oil/bacteria suspension,
Stage 3—digest.

The animal fat and digest were pumped into separate weighing boxes (dosage tank (7) and dosage tank (8) correspondingly) right prior the vacuum infusion. The suspension was pumped into a separate weighing box (dosage tank (6) with an implemented impeller in it to keep the suspension homogeneous until vacuum infusion in vacuum infusin tank (14). In this way suspension never comes into contact with the digest and the fat before vacuum infusion in vacuum infusin tank (14).

### Measured Parameters—OUTPUT

Accordingly to the production batch and factory setup parameters correct amount of suspension was used for the vacuum infusion procedure. Suspension makes a 3% of the end product. E. faecium probiotic bacteria concentration in the suspension was measured prior to vacuum infusion procedure with an average of 1.08×10¹¹ CFU/kg of the suspension.

Samples for probiotic count immediately after vacuum infusion were taken and gave a 2.05×10⁹ CFU/kg of the product.

Vacuum infused dog food kibbles afterwards went to the cooling stage. Samples after the cooling gave result above 1.27×10⁹ CFU/kg of the product right after the cooling procedure with kibble temperature of 21° C. in average at the end of the cooling stage. Moisture after cooling stage was recorded at 8.50%.

At the last production stage the product was placed in silo before packaging and a sample from silo product was sent to laboratory for Weende analysis. Results of Weende analysis are shown in Table 1.

Additionally—Probiotic Stability Measurement

The product was packed within 3 days after production to avoid all contact with air and any possible loss of bacteria quality/stability. The product was kept in a silo with controlled environmental parameters. The empty silo temperature was 19-20° C., whereas the filled silo temperature was 22° C. with a product moisture level of 7.73%.

After production the kibbles were submitted to different analysis in order to guarantee the quality of the products and the probiotic component. Analysis showed that the kibbles had an average concentration of probiotic bacteria within the range from 1.2×10⁹ CFU/kg to 1×10¹⁰ CFU/kg in the ready product.

Shelf-life test of the produced probiotic dog food confirmed the stability of the dog food for 15 months at room temperature. Probiotic dog food had a probiotic count on a level of 1.06×10⁹ CFU/kg in average during the product shelf-life period (15 months), which corresponds with the product stability.

TABLE 1
Weende analysis

| | Laboratory |
|---|---|
| | results |
| Weende Analysis: | |
| Moisture: | 7.80 |
| Dry matter: | 92.20 |
| Crude ash: | 7.52 |
| Crude fiber: | 2.31 |
| Crude protein: | 24.68 |
| Crude fat: | 11.91 |
| Sugar: | 0.61 |
| Starch: | 47.37 |
| Hygienic parameters: | |
| Salmonella: | absent/25 g |
| Enterobacteriaceae (5*) | <10/g |
| (/g): | |
| Clostridium perfringens | <10/g |
| (/g): | |

### Example 2

### Production of a Vacuum Infused Probiotic Product Comprising Probiotic Bacteria Optimized for Human Consumption

### Set-Up.

Two commercially available breakfast cereals: 4 grain snack—breakfast cereals “Neljavilja-krobuskid” (AS BalSnack International Holding, Estonia) and Breakfast cereals—Flakes with cinnamon “Oho” (UAB Naujasis Nevė\hat{z}is, Lithuania) were vacuum infused by usage of a probiotic/linseed oil suspension. Oil used in particular trial was linseed oil (OÜ Tervix, Estonia). Probiotic vacuum infused product was finally coated by low in glycemic index syrups. Commercially available probiotic bacteria formulation Protexin BALANCE (Protexin Healt Care, UK) and two different low in glycemic index syrups of Agave (Allos GmbH, Germany) and Maple (Cofradex ApS, Denmark) were used. Vacuum infusion was done by usage of Zepter VG-010 Vacsy Vacuum Pump with glass container VG-011-19 (Zepter International Group).

### Methods.

150 grams of breakfast cereals per each product and per each batch were used. Daily dose of probiotics (1 capsules containing 1×10⁸ CFU, accordingly to the producer of probiotic compound) was added per 4.5 gr of the carrier (linseed oil) making a 3% (usual production ratio) out of the product amount to be infused. Protexin BALANCE multi strain probiotic bacteria was gradually introduced into the carrier to receive a homogeneous suspension. Prepared suspensions (oil and probiotics) were continuously mixed on a Vortex prior the spraying to guarantee the homogeneity of the suspensions.

The sparing of the suspensions and syrups was done by usage of sprinklers. Before the vacuum infusion process the number of sprayings (by weight) was determined to receive a 3% coating by the bacteria suspension and 5% coating by the agave or maple syrup coating as a final layer (ratio taken from usual production data).

Prepared suspensions were used for a vacuum infusion into the matrix of a ready for consumption (extruded) human products. Multi-strain probiotic containing different suspensions were sprayed on different breakfast cereals appropriately in ratio of 4.5 gr to 150 gr of the product (3%). Afterwards product was coated by different syrups (agave vs maple) sprayed on different breakfast cereals appropriately in ratio of 7.5 gr to 150 gr of the product (5%). Product was mixed simultaneously with spraying to guarantee the equal dispersion of sprayed suspensions and coating syrups onto the different products used in the trial. Spraying of the suspensions and mixing was done in one and the same vacuum infusion glass bowl sterilized prior the trial to eliminate the probiotic count reduction and contamination between intermediate processes. Glass bowel was closed with a special vacuum control lid and vacuum atmosphere (500 mBar and 630 liters/s) was created for approx. 40 seconds in the glass bowl containing the product (until the red indicator turning on the pump).

All syrups used for final layer coating (stage 2 coating) in particular trial were preheated up to 50° C. prior the coating process to have the best viscosity for spraying. Sprayings of appropriate suspensions and final coating layers were done in 2 separate stages corresponding to the suspension (linseed oil) and syrup type (agave vs maple).

Stage 1 (3% of product weight). During the process of vacuum coating, the prepared probiotic suspension was vaporized onto the appropriate product and vacuum pressure of 500 mbar was created for approx. 40 seconds. Normal atmospheric pressure (1 bar) conditions were restored inside the vacuum infusion device (glass bowl) by gradual opening of the pressure control system.

Stage 2 (5% of product weight). Preheated up to 50° C. final coating layer (agave vs maple syrup) was vaporized onto the product and vacuum pressure of 500 mbar was created for a 20 seconds. Normal atmospheric pressure (1 bar) conditions were restored inside the vacuum infusion device (glass bowl) by gradual opening of the pressure control system.

All different products coatings with different suspensions were done at 3 parallels. All experiments were done at room temperature.

Coated with different suspensions products were sent to laboratory for a Total Viable Count (TVC) analysis and a shelf-life trial of 1 months. All samples were shipped in sterile Falcon tubes each containing approx. 5 g of sample.

### Measurements

Each parallel was measured for 0 day (immediate) count, 2 weeks, 1 month interval. Each parallel was placed under 3 different storage conditions: refrigerated condition temperature of 6-8° C., standard condition temperature of 18-24° C., and condition temperature 36-38° C. Accelerated temperature conditions were considered as x3 times faster, meaning that 1 month result of accelerated condition temperature equals to 3 month result at standard temperature condition, thus giving product stability at room temperature for 3 months.

All the TVC measurements of used raw materials are given in Table 1. and all TVC measurements of performed shelf-life trial are given in the Table 2.

TABLE 1
TVC measurements of used raw materials
Raw ingredients, TVC CFU/g

| | |
|---|---|
| Pillows bulk | 40 |
| Kibbles bulk | 10 |
| Raw bacteria powder | 9.00E+10 |
| Linseed/bacteria suspension | 1.60E+08 |

TABLE 2
TVC measurements of shelf-life trial, pillows vs kibbles

| Probiotic | Final | Storage | Bacteria count at different | | |
|---|---|---|---|---|---|
| suspension | coating | condition | time stages | | |
| carrier | layer | temp., ° C. | Day 0 | 2 week | 1 month |

Pillows, TVC CFU/g

| | | | | | |
|---|---|---|---|---|---|
| Linseed oil | Agave | 6-8 | 9.60E+05 | 9.20E+05 | 9.13E+05 |
| | | 18-24 | 9.60E+05 | 1.00E+06 | 1.25E+06 |
| | | 36-38 | 9.60E+05 | 7.23E+05 | 6.47E+05 |
| | Maple | 6-8 | 3.16E+06 | 2.23E+06 | 1.50E+06 |
| | | 18-24 | 3.16E+06 | 2.54E+06 | 1.95E+06 |
| | | 36-38 | 3.16E+06 | 8.93E+05 | 8.07E+05 |

Kibbles, TVC CFU/g

| | | | | | |
|---|---|---|---|---|---|
| Linseed oil | Agave | 6-8 | 7.73E+05 | 7.97E+05 | 7.47E+05 |
| | | 18-24 | 7.73E+05 | 8.80E+05 | 9.93E+05 |
| | | 36-38 | 7.73E+05 | 5.63E+05 | 4.63E+05 |
| | Maple | 6-8 | 1.63E+06 | 1.16E+06 | 1.13E+06 |
| | | 18-24 | 1.63E+06 | 1.00E+06 | 1.02E+06 |
| | | 36-38 | 1.63E+06 | 6.53E+05 | 5.57E+05 |

### CONCLUSIONS

Trial results clearly indicate that in initial Total Viable Count of bulk commercially available breakfast products (see Table 1, Pillows bulk and Kibbles bulk) showed dramatically lower counts than at the end of the trial after introducing the probiotic bacteria within the matrix of products under the trial (Table 2, 0 day count). This clearly indicates that the particular technology used for the vacuum infusion of the breakfast products (kibbles and pillows) described in the methods is suitable for the probiotic breakfast product manufacturing. Additionally the shelf-life study results (see Table 2) clearly indicate that both products used in particular trial (pillows and kibbles) have a good stability up to 3 months at the room temperature and all the Total Viable Count (TVC) fluctuations at different storage temperatures of different suspension carriers and final coating layers stay within 1 log.

Finalizing the trial results, all the products used in current trial together with different suspension carriers and final coating layers used, maintained the probiotic count on a sufficient level during the entire shelf-life trial period, which assures survivability of the sufficient amount of probiotic compound (daily dosage) through the stomach acids passage and further positive probiotic function implementation on a host (human) organism.

These results clearly indicate that different types of extruded food products (e.g. kibbles and pillows) may be vacuum infused with probiotics and maintain a high TVC over a longer period of time.

It should be noted that embodiments and features described in the context of one of the aspects of the present invention also apply to the other aspects of the invention.

All patent and non-patent references cited in the present application, are hereby incorporated by reference in their entirety.

1. A production plant for vacuum infusing a food product comprising:
a first storage tank for storing a probiotic suspension, said first storage tank being connected to a first dosage tank for dosing a probiotic suspension,
a second storage tank for storing a second solution, said second storage tank being connected to a second dosage tank for dosing the second solution,
wherein the first dosage tank and the second dosage tank are connected to a vacuum infusion tank by one or more spraying nozzles leading into the vacuum infusion tank, and wherein at least the first dosage tank is individually connected to the vacuum infusion tank by one or more first spraying nozzles leading into the vacuum infusion tank.

2-16. (canceled)

17. The production plant according to claim 1, further comprising at least a third storage tank for storing a solution, said third storage tank being connected to a third dosage tank for dosing the third solution through one or more spraying nozzles.

18. The production plant according to claim 17, further comprising at least a fourth storage tank for storing a solution, said fourth storage tank being connected to a fourth dosage tank for dosing a solution through one or more spraying nozzles.

19. The production plant according to claim 18, wherein at least one of the following dosage tanks also is individually connected to the vacuum infusion tank by one or more spraying nozzles: the second dosage tank, the third dosage tank or the fourth dosage tank.

20. The production plant according to claim 18, wherein each of the following dosage tanks also is individually connected to the vacuum infusion tank by one or more spraying nozzles: the second dosage tank, the third dosage tank and the fourth dosage tank.

21. The production plant according to claim 1, wherein the orifice of each of the spraying nozzles has a cross-sectional area of 1-250 mm².

22. The production plant according to claim 1, wherein a first mixing tank is connected to the first storage tank through a bottom outlet in the first mixing tank, and wherein the probiotic suspension can be passed from the first mixing tank to the first storage tank by gravity.

23. The production plant according to claim 22, wherein the connection between the first mixing tank and the first storage tank does not comprise a vacuum suction unit.

24. The production plant according to claim 22, wherein the connection between the first mixing tank and the first storage tank does not comprise a positive displacement unit.

25. The production plant according to claim 1, wherein the first storage tank comprises a rotating impeller or a rotating mixing tank or both.

26. The production plant according to claim 1, wherein the vacuum infusion tank comprises a rotating impeller or a rotating mixing tank.

27. The production plant according to claim 1, wherein the vacuum infusion tank comprises at least one opening for applying the uncoated food product to said vacuum infusion tank.

28. The production plant according to claim 1, wherein the vacuum infusion tank is further connected to an collection tank for passing the coated food product from the infusion tank to the collection tank, and wherein the collection tank is further connected to at least one vessel containing one or more substances to be applied to the collection vessel.

29. The production plant according to claim 28, wherein the collection tank comprises a rotating impeller or a rotating mixing tank or both.

30. The production plant according to claim 1, wherein at least the first storage tank and the first dosage tank are configured to maintain the temperature of the probiotic suspension in the range of 15° C. to 29° C.

31. The production plant according to claim 1, wherein the plant further comprises a control unit for controlling at least one of the activities selected from the group consisting of: controlling the temperature in at least one of the storage tanks, controlling the temperature in at least one of the dosage tanks, controlling opening and closing of inlets and outlets between two or more of the tanks, controlling the amount of liquid sprayed through the nozzles, controlling the pressure in the vacuum tank, and controlling the mixing time.
